(19) United States
(12) Patent Application Publication
(10) Pub. No.: US 2025/0342411 A1
(43) Pub. Date: Nov. 6, 2025

(54) SYSTEMS AND METHODS TO GENERATE TRAINING MODULES FOR A FACILITY

(71) Applicant: HONEYWELL INTERNATIONAL INC., Charlotte, NC (US)

(72) Inventors: Lakshminarayana Paila, Knoxville, TN (US); Ankit Singh, Apex, NC (US)

(21) Appl. No.: 18/653,981

(22) Filed: May 3, 2024

(51) Int. Cl. G06Q 10/0631

(52) U.S. Cl. CPC G06Q 10/0631

(57) ABSTRACT

Various embodiments described herein relate to systems and methods for generating training modules to train workforces in a facility. In this regard, one or more documents related to one or more operations in the facility is initially created. Then, a user in the facility provides a first input associated with the one or more documents. Based on the first input, one or more topics are extracted from the one or more documents. The extracted topics are then updated in a database as well. Further, one or more training templates are generated for the extracted topics. The user then provides a second input indicative of one or more specifications for the generation of the one or more training modules. Based on the one or more specifications, the one or more training modules are generated using the one or more training templates.

### TECHNICAL FIELD

The present disclosure relates generally to training workforces in facilities, and more particularly to systems and methods for generating training modules to train workforces in the facilities.

### BACKGROUND

Generally, facilities such as pharmaceutical industries, factories, industrial plants, warehouses, and/or the like often include huge workforce to facilitate various operations in the facilities. In this regard, the workforce is often split into several groups of workers/personnel to facilitate certain operations in the facilities. For example, in a facility such as a pharmaceutical industry, there can be several operations related to research and development, material handling, shipping, law/legal, and/or the like. To carry out such specific operations, workforce of the pharmaceutical industry can be split into multiple groups. Said alternatively, for example, a first group of the workforce can be assigned to support material handling operations while a second group of the workforce can be assigned to support legal operations. On an overall, for such diverse operations to be smooth in the facilities, performance of the workforce plays an important role. And the performance of the workforce is heavily dependent on skill set of the workforce.

At times, the facilities often rely on subject matter experts to train their workforce in order to improve the skill set of their workforce or cross train the workers on different operations. For example, the facilities may hire subject matter experts or technical experts to create manuals or training modules for training. However, this has associated challenges. For instance, the experts may manually create appropriate manuals or training modules for training the diverse workforce. In this regard, the experts may collate huge volume of relevant documents, classify the documents, and then select only particular documents for training workers on specific operations. Often, such manual work is error prone as there can be a chance that the experts may wrongly classify a document for a specific operation, wrongly select a particular document, miss a document for creating a training module, and/or the like. Also, manually creating several such manuals or modules is a cumbersome task and this consumes lot of time and efforts. This can result in scenarios where the workers may not get the required training relevant to their domain/operations to upskill themselves. Accordingly, this often results in inefficient operations in the facilities along with unoptimized utilization of both electronic and human resources of the facilities while making training the workforce a challenging task.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates a schematic diagram showing an exemplary environment comprising multiple facilities, in accordance with one or more example embodiments described herein.

FIG. 2 illustrates a schematic diagram showing an implementation of a controller that may execute techniques in accordance with one or more example embodiments described herein.

FIG. 3 illustrates a schematic diagram showing an implementation of an exemplary module generating system, in accordance with one or more example embodiments described herein.

FIG. 4 illustrates a flowchart showing a method described in accordance with one or more example embodiments described herein.

FIG. 5 illustrates a flowchart showing a method described in accordance with one or more example embodiments described herein.

FIG. 6 illustrates a flowchart showing a method described in accordance with one or more example embodiments described herein.

FIG. 7 illustrates a flowchart showing a method described in accordance with one or more example embodiments described herein.

FIG. 8 illustrates a flowchart showing a method described in accordance with one or more example embodiments described herein.

FIG. 9 illustrates a flowchart showing a method described in accordance with one or more example embodiments described herein.

FIG. 10 illustrates a flowchart showing a method described in accordance with one or more example embodiments described herein.

FIG. 11 illustrates a flowchart showing a method described in accordance with one or more example embodiments described herein.

### SUMMARY

The details of some embodiments of the subject matter described in this specification are set forth in the accompanying drawings and the description below. Other features, aspects, and advantages of the subject matter will become apparent from the description, the drawings, and the claims.

In accordance with one or more example embodiments of the current disclosure, a method for generating one or more training modules is described herein. In this regard, the method comprises creating one or more documents related to one or more operations in a facility. Further, the method comprises receiving, via a user interface, a first input from a user in the facility such that the first input is associated with the one or more documents. Then, the method comprises extracting one or more topics from the one or more documents based at least on the first input. Furthermore, the method comprises updating a database with the one or more topics extracted from the one or more documents. Also, the method comprises generating one or more training templates for the one or more topics. Then, the method comprises receiving, via the user interface, a second input from the user such that the second input comprises one or more specifications. The method then comprises generating the one or more training modules using the one or more training templates based on the second input.

In accordance with another embodiment of the current disclosure, a system for generating one or more training modules is described herein. The system comprises a processor and a memory communicatively coupled to the processor, wherein the memory comprises one or more instructions which when executed by the processor, cause the processor to create one or more documents related to one or more operations in a facility. The processor is also configured to receive, via a user interface, a first input from a user in the facility such that the first input is associated with the one or more documents. Further, the processor is configured to extract one or more topics from the one or more documents based at least on the first input. Furthermore, the processor is configured to update a database with the one or more topics extracted from the one or more documents. Then, the processor is configured to generate one or more training templates for the one or more topics. Also, the processor is configured to receive, via the user interface, a second input from the user such that the second input comprises one or more specifications. The processor is also configured to generate the one or more training modules using the one or more training templates based on the second input.

In accordance with yet another embodiment of the current disclosure, a non-transitory, computer-readable storage medium having instructions stored thereon and executable by one or more processors is described herein. In this regard, the instructions when executed by one or more processors cause the one or more processors to create one or more documents related to one or more operations in a facility. The one or more processors are also configured to receive, via a user interface, a first input from a user in the facility such that the first input is associated with the one or more documents. Further, the one or more processors are configured to extract one or more topics from the one or more documents based at least on the first input. Furthermore, the one or more processors are configured to update a database with the one or more topics extracted from the one or more documents. Then, the one or more processors are configured to generate one or more training templates for the one or more topics. Also, the one or more processors are configured to receive, via the user interface, a second input from the user such that the second input comprises one or more specifications. The one or more processors are also configured to generate one or more training modules using the one or more training templates based on the second input.

The above summary is provided merely for purposes of providing an overview of one or more exemplary embodiments described herein so as to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained in the following description and its accompanying drawings.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### DETAILED DESCRIPTION OF THE DRAWINGS

Reference will now be made in detail to embodiments, examples of which are illustrated in the accompanying drawings. In the following detailed description, numerous specific details are set forth in order to provide a thorough understanding of the various described example embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase can be included in at least one example embodiment of the present disclosure, and can be included in more than one example embodiment of the present disclosure (importantly, such phrases do not necessarily refer to the same example embodiment).

The word “exemplary” is used herein to mean “serving as an example, instance, or illustration.” Any implementation described herein as “exemplary” is not necessarily to be construed as preferred or advantageous over other implementations. If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature can be optionally included in some example embodiments, or it can be excluded.

Often, facilities employ huge workforces to ensure smooth operations. However, for the operations to be hassle free in the facilities, skill set of the workforces plays a significant role. At times, it so happens that workers in the facilities are skilled only on those competencies required for specific operations which they handle on day-to-day basis. In such situations, whenever there is a requirement of workers for other operations, the workers may be unable to handle such operations. This eventually leads to downtime in the facilities resulting in unoptimized usage of resources and inefficient operations with reduced throughput in the facilities. Yet the facilities may arrange for certain trainings to upskill their workforces. For example, the facilities may hire subject matter experts to create training modules or manually train the workforces. But this has associated shortcomings too. Such experts rely on documentations related to operations of the facilities to create a structure or set a context for training. Given that the operations of the facilities belong to diverse domains, volume of the documentations is also huge. Often such experts spend substantial time on collating documents, segregating/classifying them as appropriate, and then using content in relevant document to create training modules. This manual work is time consuming and constitutes to a cumbersome task. Also, the experts may fail to scale up to the huge number of documentations in order to accurately extract the required information. For example, the experts may: wrongly segregate a document under a wrong category/topic, fail to consider interrelationship between operations in order to classify the documents, miss certain documents while segregating, etc.. Additionally, it is to be noted that the documentations can have audio, video, and/or textual content. In this regard, it becomes even more complex for the experts to rightly classify the documents and identify content in the documents. In view of such shortcomings, effective training may be unavailable to the workers in order to upskill themselves. Also, with advent of new technologies, the facilities often incorporate new procedures and new practices. In this regard, the workers are also expected to keep up with new procedures and new practices. When effective training is unavailable to the workers, they cannot work up to the desired expectations resulting in decreased worker productivity and reduced efficiency in operations of the facilities.

Thus, to address the above challenges, various examples of systems and methods described herein facilitate generation of one or more training modules to train workers/personnel in a facility. Examples of the facility can be, but not limited to pharmaceutical industries, factories, industrial plants, warehouses, etc.. To generate the training modules, for instance, the method described herein is performable via a cloud platform such as Amazon Web Services (AWS). The method initially requires creation of documents related to several operations in a facility. For example, this includes building a collection/repository of documents such as, but not limited to manuals, research papers, white papers, journals, standard operating procedures, customer submitted documents, other related documentations, etc., related to various operations in the facility. Also, the operations in the facility can be associated with diverse domains such as research and development, manufacturing, shipping, material handling, legal/compliance, complaints, quality assurance, and/or the like. Also, it is to be noted that the documents can comprise information in one or more of: a textual form, an audio form, or a video form. The method also provides the flexibility to build repository of the documents based on interests of users/customers as well. The method then includes receiving a first input from a user in the facility. In this regard, the user provides the first input via a user interface such that the first input is associated with the documents. For example, the first input can be indicative of: an approval from customer or admin in the facility for addition of documents into the repository upon review of the documents, comments/feedback on documents, requirements such as dimensions, versioning, water mark, etc., of documents, and/or the like.

The method further involves extracting topics from the documents based at least on the first input. In this regard, for example, upon receiving the appropriate approvals/information from the users, the topics are extracted from the documents. To extract the topics from the documents, the method described herein uses Language Learning Models (LLMs) deployed in the cloud platform. Provided that huge volume of documents related to diverse topics of all operations are present in a single repository, the LLMs of the cloud platform facilitate automatic extraction of topics from the documents. The extraction of topics is dependent on factors such as, but not limited to operations in the facility, customer requirements, training requirements, and/or the like. In this regard, the LLMs initially convert the documents into vectorial representations (alternatively, referred to as vectors). Then, using the vectors, the LLMs identify relevant topics present in the documents. Also, the method includes classifying the documents using the extracted topics by the LLMs. In this regard, the relevant content present in the documents is put under appropriate topics for further usage. It is to be noted that the extraction of topics and/or classification of the documents is done based on a threshold/benchmark defined by a customer or admin in the facility. Once the topics are extracted, the repository is updated with the extracted topics and/or the classified documents as well.

The method then involves generating training templates using the extracted topics by the LLMs. In this regard, the templates comprise one or more fields that are required to further generate the training modules. The one or more fields can be determined based on the operations of facility, customer/user requirements, training requirements, content in the documents, and/or the like. Also, the one or more fields are filled using the content present in the documents of the appropriate topics while generating the training modules. In this regard, the templates act as a framework to generate the appropriate training modules. Also, the templates are classifiable under different categories depending upon operations/domains of the facility, end user targeted for training, complexity level of training requirements, topics, end customer, and/or the like. Some of the example categories can be, but not limited to novice templates, intermediate templates, expert templates, templates with visuals or videos, operations/domain specific templates, customer specific templates, topic specific templates, etc..

The method then involves the user providing a second input via the user interface. The second input can be associated with one or more specifications desired by the user. Additionally, the second input can be provided by the user based on the topics extracted from the documents by the LLMs as well. For example, the one or more specifications can be, but not limited to description of training, type of training, level of training, operation/domain for which training is required, worker or group of workforces that is to be trained, threshold beyond which content has to be selected, etc.. Based on the second input, the method comprises generating the training modules using the training templates. In this regard, the LLMs select the appropriate templates based on the second input to generate the training modules. Also, the LLMs make sure that appropriate content from the documents is filled into the one or more fields of the templates in order to generate the training modules. Additionally, the method is also capable of regularly updating documents, topics, and/or templates as necessary. Also, the method generates new topics, new templates, and/or new content based on inter-relationship between the existing documents, topics, and/or templates as needed.

Accordingly, various embodiments of the systems and methods described herein facilitates automated generation of training modules for the facilities. This significantly reduces time and efforts that has to be put in by the experts to generate the training modules. Further, various embodiments of the systems and methods described herein provides accurately tailored content from huge set of documentations which can be specifically targeted for specific set of workforces. Additionally, the training modules are suitable/compatible for wide range of end uses such as offline trainings, computer-based trainings, custom exams, online exams, etc.. Thus, the training modules described herein facilitate the facilities to upskill their workforce in an optimized way which eventually enhances productivity of workforces and/or operations in the facilities.

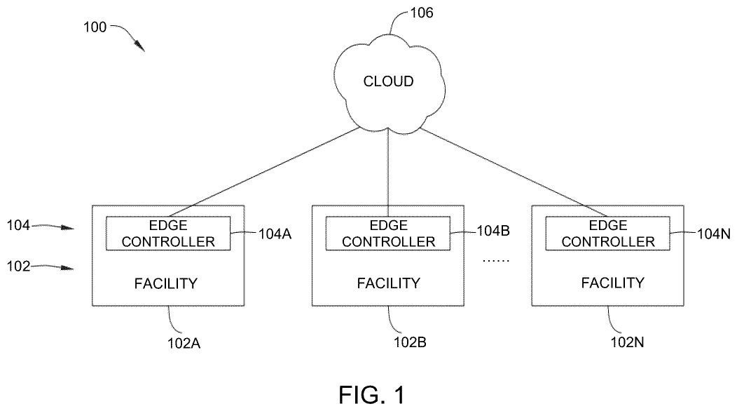

FIG. 1 illustrates a schematic diagram showing an exemplary environment comprising multiple facilities. According to various example embodiments described herein, an exemplary environment 100 comprises one or more facilities 102a, 102b, . . . 102n (collectively “facilities 102”). In some example embodiments, a facility of the one or more facilities 102a, 102b, . . . 102n may correspond to, for example, a commercial building, an institutional building, a factory, an industry, an IT park, a corporate office, a logistics environment, an airport premises, a pharmaceutical industry, a transportation hub, a material handling environment, a warehouse, a supply chain environment, a data center, an industrial plant, and/or the like. In some example embodiments, the one or more facilities 102a, 102b, . . . 102n in the illustrative environment 100 may be of same type. In some example embodiments, the one or more facilities 102a, 102b, . . . 102n in the illustrative environment 100 may be of different type. As it may be understood, in some example embodiments described herein, a facility of the one or more facilities 102a, 102b, . . . 102n often employs several workers or personnel to handle numerous operations in the facility. In this regard, the facility may include several groups of workers to facilitate certain operations in the facility. For example, in a facility such as a pharmaceutical industry, there may be several operations related to research and development, material handling, shipping, law/legal, and/or the like. To carry out such specific operations, workforce of the facility is often split into multiple groups. For example, a first group of the workforce can be assigned to support material handling operations while a second group of the workforce can be assigned to support legal operations. At times, the workers may be expected to render support to other operations as well. In this regard, the workers need to be skilled or trained enough to handle such operations. Additionally, at times, the workers need to upskill themselves as well. Per this aspect, the facilities 102 provide appropriate training to such workers.

In some example embodiments, a cloud 106 is operably coupled with one or more facilities 102a, 102b, . . . 102n, meaning that communication between the cloud 106 and one or more facilities 102a, 102b, . . . 102n is enabled. The cloud 106 may represent distributed computing resources, software, platform or infrastructure services which can enable data handling, data processing, data management, and/or analytical operations on the data exchanged & transacted in the facilities 102. In some example embodiments described herein, the cloud 106 represents a platform that comprises one or more services to manage training in the facilities 102. Per this aspect, the one or more services of the cloud 106 appropriately handle, process, and/or manage the data at the cloud 106 to generate one or more training modules. In this regard, the data at the cloud 106 corresponds to one or more documents associated with the facilities 102. The one or more documents may be created by users and/or customers associated with the facilities 102. For instance, the one or more documents may be, but not limited to at least one of one or more manuals, one or more research papers, one or more white papers, one or more journals, one or more standard operating procedures, one or more customer submitted documents, and/or the like. Also, the cloud 106 may include or generate models required to handle, process, and/or manage the data in order to generate the one or more training modules for a respective facility. In some example embodiments, the cloud 106 includes one or more servers that may be programmed to communicate with the one or more facilities 102a, 102b, . . . 102n and to exchange data as appropriate. The cloud 106 may be a single computer server or may include a plurality of computer servers. In some example embodiments, the cloud 106 may represent a hierarchal arrangement of two or more computer servers, where perhaps a lower-level computer server (or servers) processes the data, for example, while a higher-level computer server oversees operation of the lower-level computer server or servers.

Each of the facilities 102 may include a variety of different operations. For example, in a facility such as a pharmaceutical industry, there may be several operations related to research and development, material handling, shipping, quality assurance, law/legal, and/or the like. There may be several documents associated with each of such diverse operations too. For example, a customer may create a document representing a complaint associated with quality of products from the facility. In another example, an admin of the facility may set a standard operating procedure for material handling. Yet in another example, a worker in the facility may create a document briefing details regarding research and development actions. Similarly, users and/or customers associated with the facility may create other similar documents for the various operations of the facility. In the example shown in FIG. 1, each of the one or more facilities 102a, 102b, . . . 102n includes a respective edge controller (alternatively, edge gateway) 104a, 104b, . . . 104n (collectively “edge controllers 104” or “edge gateways 104”). In some example embodiments, each of one or more edge controllers 104a, 104b, . . . 104n is configured to receive the data from the respective facilities 102. In some examples, the one or more edge controllers 104a, 104b, . . . 104n may operate as intermediary node to transact the data between the facilities 102 and/or the cloud 106. In this regard, the data includes one or more documents associated with the operations in the facilities 102. Additionally, the data also includes metadata and/or other relevant data associated with the facilities 102. In some examples, each of the one or more edge controllers 104a, 104b, . . . 104n is capable of receiving the data from disparate data sources e.g., but not limited to, in different data formats and/or using various data communication protocols, from the facilities 102. In this regard, each of the one or more edge controllers 104a, 104b, . . . 104n can receive & filter the data and translate the data into a common language and/or format (e.g. normalized data) for subsequent communication to the cloud 106. The common language and/or format may be compatible with and expected by the cloud 106.

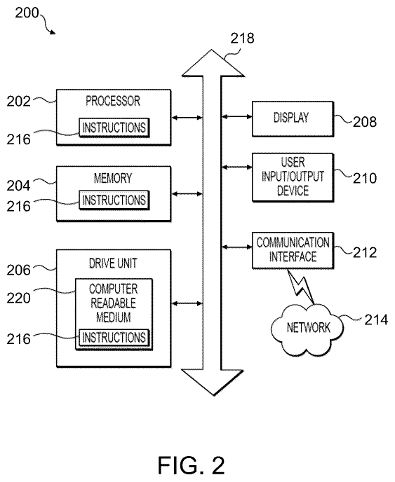

FIG. 2 illustrates a schematic diagram showing an implementation of a controller that may execute techniques in accordance with one or more example embodiments described herein. In one or more example embodiments, controller 200 described herein may include a set of instructions that can be executed to cause the controller 200 to perform any one or more of the methods or computer-based functions disclosed herein. The controller 200 may operate as a standalone device or may be connected, e.g., using a network, to other computer systems or peripheral devices.

In a networked deployment, the controller 200 may operate in the capacity of a server or as a client in a server-client user network environment, or as a peer computer system in a peer-to-peer (or distributed) network environment. The controller 200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 200 can be implemented using electronic devices that provide voice, video, or data communication. Further, while the controller 200 is illustrated as a single system, the term “system” shall also be taken to include any collection of systems or sub-systems that individually or jointly execute a set, or multiple sets, of instructions to perform one or more computer functions.

As illustrated in FIG. 2, the controller 200 may include a processor 202, e.g., a central processing unit (CPU), a graphics processing unit (GPU), or both. The processor 202 may be a component in a variety of systems. For example, the processor 202 may be part of a standard computer. The processor 202 may be one or more general processors, digital signal processors, application specific integrated circuits, field programmable gate arrays, servers, networks, digital circuits, analog circuits, combinations thereof, or other now known or later developed devices for analyzing and processing data. The processor 202 may implement a software program, such as code generated manually (i.e., programmed).

The controller 200 may include a memory 204 that can communicate via a bus 218. The memory 204 may be a main memory, a static memory, or a dynamic memory. The memory 204 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 204 includes a cache or random-access memory for the processor 202. In alternative implementations, the memory 204 is separate from the processor 202, such as a cache memory of a processor, the system memory, or other memory. The memory 204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 204 is operable to store instructions executable by the processor 202. The functions, acts or tasks illustrated in the figures or described herein may be performed by the processor 202 executing the instructions stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the controller 200 may further include a display 208, such as a liquid crystal display (LCD), an organic light emitting diode (OLED), a flat panel display, a solid-state display, a cathode ray tube (CRT), a projector, a printer or other now known or later developed display device for outputting determined information. The display 208 may act as an interface for the user to see the functioning of the processor 202, or specifically as an interface with the software stored in the memory 204 or in the drive unit 206. Additionally or alternatively, the controller 200 may include an input/output device 210 configured to allow a user to interact with any of the components of controller 200. The input/output device 210 may be a number pad, a keyboard, or a cursor control device, such as a mouse, or a joystick, touch screen display, remote control, or any other device operative to interact with the controller 200. The controller 200 may also or alternatively include drive unit 206 implemented as a disk or optical drive. The drive unit 206 may include a computer-readable medium 220 in which one or more sets of instructions 216, e.g. software, can be embedded. Further, the instructions 216 may embody one or more of the methods or logic as described herein. The instructions 216 may reside completely or partially within the memory 204 and/or within the processor 202 during execution by the controller 200. The memory 204 and the processor 202 also may include computer-readable media as discussed above.

In some systems, a computer-readable medium 220 includes instructions 216 or receives and executes instructions 216 responsive to a propagated signal so that a device connected to a network 214 can communicate voice, video, audio, images, or any other data over the network 214. Further, the instructions 216 may be transmitted or received over the network 214 via a communication port or interface 212, and/or using a bus 218. The communication port or interface 212 may be a part of the processor 202 or may be a separate component. The communication port or interface 212 may be created in software or may be a physical connection in hardware. The communication port or interface 212 may be configured to connect with a network 214, external media, the display 208, or any other components in controller 200, or combinations thereof. The connection with the network 214 may be a physical connection, such as a wired Ethernet connection or may be established wirelessly as discussed below. Likewise, the additional connections with other components of the controller 200 may be physical connections or may be established wirelessly. The network 214 may alternatively be directly connected to a bus 218.

While the computer-readable medium 220 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 220 may be non-transitory, and may be tangible. The computer-readable medium 220 can include a solid-state memory such as a memory card or other package that houses one or more non-volatile read-only memories. The computer-readable medium 220 can be a random-access memory or other volatile re-writable memory. Additionally or alternatively, the computer-readable medium 220 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 200 may be connected to a network 214. The network 214 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 214 may include wide area networks (WAN), such as the Internet, local area networks (LAN), campus area networks, metropolitan area networks, a direct connection such as through a Universal Serial Bus (USB) port, or any other networks that may allow for data communication. The network 214 may be configured to couple one computing device to another computing device to enable communication of data between the devices. The network 214 may generally be enabled to employ any form of machine-readable media for communicating information from one device to another. The network 214 may include communication methods by which information may travel between computing devices. The network 214 may be divided into sub-networks. The sub-networks may allow access to all of the other components connected thereto or the sub-networks may restrict access between the components. The network 214 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof. It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

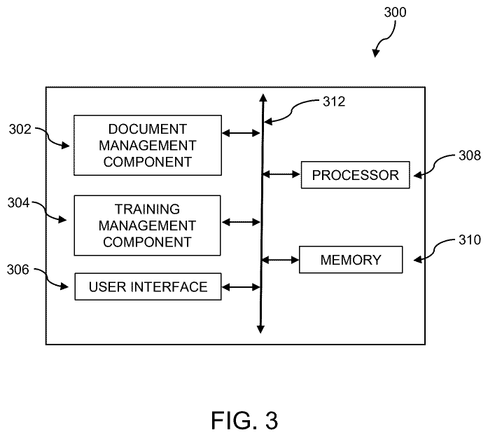

FIG. 3 illustrates a schematic diagram showing an implementation of an exemplary module generating system, in accordance with one or more example embodiments described herein. In one or more example embodiments, the module generating system 300 described herein generates one or more training modules required to train workforces in a facility (for instance, one or more facilities 102a, 102b, . . . 102n as described in FIG. 1 of the current disclosure). To generate the one or more training modules, the module generating system 300 considers one or more documents related to several operations in the facility. For example, this includes utilizing a collection/repository of documents such as, but not limited to manuals, research papers, white papers, journals, standard operating procedures, customer submitted documents, other related documentations, etc., related to various operations in the facility. Then, based on input(s) (say, first input(s)) from user(s) such as admins or personnel associated with the facility, the module generating system 300 extracts one or more topics from the documents. Further, the module generating system 300 also classifies the one or more documents based on the extracted topics. Per such aspects, the module generating system 300 utilizes Language Learning Models (LLMs) to extract topics and classify documents. Once the topics are extracted and documents are classified, the repository is updated with the same. Further, the module generating system 300 generates one or more training templates using the topics and/or the classified documents. The one or more training templates comprise one or more fields that are required to further generate the one or more training modules. In this regard, the one or more training templates act as a framework to generate the appropriate training modules for the facility. Upon the user(s) such as admins or personnel associated with the facility providing further input(s) (say, second input(s)), the module generating system 300 generates the one or more training modules using appropriate training templates. Per this aspect, the module generating system 300 utilizes the LLMs to make sure that appropriate content from relevant documents is filled into the one or more fields of the templates in order to generate the training modules. Accordingly, in some example embodiments, the system 300 facilitates a practical application of data analytics technology and/or digital transformation technology to generate suitable training modules in facility.

In some example embodiments, the module generating system 300 is a server system (e.g., a server device) that facilitates a data analytics platform between one or more computing devices, one or more data sources, and/or one or more facilities. In some example embodiments, the module generating system 300 is a device with one or more processors and a memory. Also, in some example embodiments, the module generating system 300 is implementable via the cloud 106. In this regard, in some example embodiments, the cloud 106 may correspond to a platform such as Amazon Web Services (AWS). The module generating system 300 is implementable in one or more facilities related to one or more technologies, for example, but not limited to, enterprise technologies, connected building technologies, industrial technologies, Internet of Things (IoT) technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, life science technologies, process plant technologies, procurement technologies, and/or one or more other technologies.

In some example embodiments, the module generating system 300 comprises one or more components such as, a document management component 302, a training management component 304, and/or a user interface 306. Additionally, in one or more example embodiments, the module generating system 300 comprises a processor 308 and/or a memory 310. In one or more example embodiments, one or more components of the module generating system 300 may be communicatively coupled to processor 308 and/or a memory 310 via a bus 312. In certain example embodiments, one or more aspects of the module generating system 300 (and/or other systems, apparatuses and/or processes disclosed herein) constitute executable instructions embodied within a computer-readable storage medium (e.g., the memory 310). For instance, in an example embodiment, the memory 310 stores computer executable component and/or executable instructions (e.g., program instructions). Furthermore, the processor 308 facilitates execution of the computer executable components and/or the executable instructions (e.g., the program instructions). In an example embodiment, the processor 308 is configured to execute instructions stored in the memory 310 or otherwise accessible to the processor 308.

The processor 308 is a hardware entity (e.g., physically embodied in circuitry) capable of performing operations according to one or more embodiments of the disclosure. Alternatively, in an example embodiment where the processor 308 is embodied as an executor of software instructions, the software instructions configure the processor 308 to perform one or more algorithms and/or operations described herein in response to the software instructions being executed. In an example embodiment, the processor 308 is a single core processor, a multi-core processor, multiple processors internal to the module generating system 300, a remote processor (e.g., a processor implemented on a server), and/or a virtual machine. In certain example embodiments, the processor 308 is in communication with the memory 310, the document management component 302, the training management component 304, and/or the user interface 306 via the bus 312 to, for example, facilitate transmission of data between the processor 308, the memory 310, the document management component 302, the training management component 304, and/or the user interface 306. In some example embodiments, the processor 308 may be embodied in a number of different ways and, in certain example embodiments, includes one or more processing devices configured to perform independently. Additionally or alternatively, in one or more example embodiments, the processor 308 includes one or more processors configured in tandem via bus 312 to enable independent execution of instructions, pipelining of data, and/or multi-thread execution of instructions.

The memory 310 is non-transitory and includes, for example, one or more volatile memories and/or one or more non-volatile memories. In other words, in one or more example embodiments, the memory 310 is an electronic storage device (e.g., a computer-readable storage medium). The memory 310 is configured to store information, data, content, one or more applications, one or more instructions, or the like, to enable the module generating system 300 to carry out various functions in accordance with one or more embodiments disclosed herein. In accordance with some example embodiments described herein, the memory 310 may correspond to an internal or external memory of the module generating system 300. In some examples, the memory 310 may correspond to a database communicatively coupled to the module generating system 300. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor circuitry, an executable component, a thread of instructions, a program, and/or a computer entity.

In one or more example embodiments, the document management component 302 of the module generating system 300 creates the one or more documents related to one or more operations in the facility. In this regard, the document management component 302 builds a collection of documents related to diverse operations/domains in the memory 310 (alternatively, referred to as database as well) and/or the document management component 302 as well. The one or more documents may be regularly created or provided by one or more users associated with the facility. In this regard, the one or more users may be admins or personnel or even customers associated with the facility. For example, in a facility such as a pharmaceutical industry, the one or more operations may be related to research and development, manufacturing, shipping, material handling, legal, complaints, quality assurance, and/or the like. At one instance, a customer may create a document representing a complaint associated with quality of products from the pharmaceutical industry. In another instance, an admin of the pharmaceutical industry may set a standard operating procedure for material handling. Yet in another instance, a worker in the pharmaceutical industry may create a document briefing details regarding research and development actions. When users create such documents, the document management component 302, for instance, receives such documents via computing devices (not shown) associated with the users. Also, in some example embodiments, the users can create one or more documents at the document management component 302 as well. Further, the document management component 302 makes sure to update the database by storing all of those documents in order to create a collection/repository of documents. Generally, the one or more documents related to the facility may be, but not limited to one or more manuals, one or more research papers, one or more white papers, one or more journals, one or more standard operating procedures, and one or more customer submitted documents. Also, it is to be noted that the one or more documents may comprise information in one or more of: a textual form, an audio form, or a video form. For example, a manual related to operating a machine may comprise textual instructions along with pictorial representation of the instructions, images of the machine, etc.. In another example, a customer submitted document may comprise a voice note or an audio clip indicative of feedback on services provided by the facility. Yet in another example, a journal may comprise a video detailing research and development activities in the facility.

Additionally, in one or more example embodiments described herein, the document management component 302 allows the users to view and/or edit the documents. In this regard, the document management component 302 via the user interface 306 allows the users to review one or more existing documents in the database and edit accordingly. For example, an admin in the facility may review the existing documents to verify whether relevant documents are stored in the database, whether the database is up to date with latest documents, and/or the like. Further, the admin may also provide one or more comments via the user interface 306 as a feedback based at least on the review of the existing documents. For instance, the admin may provide a comment stating that the database is up to date. In another instance, the admin may provide a comment stating that some of the documents are irrelevant in the database. Yet in another instance, the admin may suggest that additional documents related to certain specific domains need to be updated in the database. Also, the users may edit some of the documents based on the review. For instance, a worker in the facility may rename a document. In another instance, a worker in the facility may delete an irrelevant document. Further, in some example embodiments, the document management component 302 allows addition of new documents to the database as well. In this regard, the document management component 302 regularly updates the database with one or more new documents as and when they are created/received at the document management component 302. Also, one or more new documents are added to the database based at least on the comments from the users. For example, if a comment suggests that additional documents related to certain specific domains need to be updated, the required additional documents may be updated in the database. Further, one or more new documents are added based at least on an approval from an admin in the facility. This is to make sure that only relevant or appropriate documents are added to the database. Furthermore, in some example embodiments, the document management component 302 allows the users to define one or more requirements associated with the one or more documents. For instance, the users may define, via the user interface 306, the one or more requirements which may be, but not limited to dimension, versioning, and water mark related to the one or more documents. In this regard, the one or more requirements facilitate the documents to have suitable formatting features.

Then, in one or more example embodiments, the training management component 304 extracts one or more topics from the one or more documents. In some example embodiments, the training management component 304 may automatically extract the one or more topics in response to updating the database with the one or more documents by the document management component 302. Whereas in some example embodiments, the training management component 304 may extract the one or more topics based at least on the approval, the one or more comments, and/or the one or more requirements provided by the users. The training management component 304 utilizes one or more language learning models (LLMs) to extract the one or more topics. In this regard, the language learning models parse the one or more documents initially to convert content in the one or more documents into one or more vectorial representations. For example, if a manual has an image of a machine, the LLMs determine a vector equivalent representation which corresponds to the image of the machine. In another example, if a customer submitted document has feedback as text, the LLMs determine a vector equivalent representation which corresponds to the textual feedback. Further, in one or more example embodiments, the training management component 304 identifies the one or more topics in the one or more documents based at least on the one or more vectorial representations. For example, if a manual describes a procedure to be followed for material handling as textual instructions, the LLMs determine a vector equivalent representation of each textual instruction. In this regard, the manual may be identified under the topic of material handling operations based on the vector equivalent representation of each textual instruction. Then, if the same manual describes another procedure related to legal aspects of the facility as a video, the LLMs determine a vector equivalent representation of content described in the video. In this regard, the manual may be also identified under the topic of legal operations based on the vector equivalent representation of content described in the video. Upon identification of the one or more topics using appropriate vector equivalent representations, the training management component 304 further classifies the one or more documents based on the one or more extracted topics. Also, the training management component 304 classifies the appropriate vector equivalent representations and/or the content in the one or more documents under the one or more extracted topics. For example, the aforementioned manual is classified under both of material handling and legal operations. Further, the vector equivalent representation of each textual instruction may be classified under the topic of material handling operations while the vector equivalent representation of content described in the video may be classified under the topic of legal operations too. Also, it is to be noted that the training management component 304 classifies the one or more documents, the appropriate vector equivalent representations, and/or the content based on the extracted topics, user/customer requirements, type of operations, content in the one or more documents, and/or the like. In this regard, the training management component 304 facilitates structured classification of the one or more documents along with the appropriate vector equivalent representations and/or the content in the one or more documents.

In one or more example embodiments, the training management component 304 updates the database with the one or more topics extracted from the one or more documents. Additionally, in one or more example embodiments, the training management component 304 also updates the database with the appropriate vector equivalent representations and/or the content in the one or more documents as well. While updating the database, the training management component 304 makes sure to facilitate storage of the one or more topics, the one or more classified documents, the appropriate vector equivalent representations, and/or the content in the one or more documents in a structured manner. Also, in some example embodiments, the one or more topics, the one or more classified documents, the appropriate vector equivalent representations, and/or the content in the one or more documents may be stored in the training management component 304 as well. Then, in one or more example embodiments, the training management component 304 generates one or more training templates for the one or more topics. In this regard, the training management component 304 utilizes the LLMs to generate the one or more training templates based on the one or more topics. In this regard, the LLMs access the one or more topics, the one or more classified documents, the appropriate vector equivalent representations, and/or the content in the one or more documents. Further, the LLMs identify one or more fields to be included in the one or more training templates based on the one or more topics. Also, the one or more fields are identified based on the one or more classified documents, the appropriate vector equivalent representations, and/or the content in the one or more documents as well. Additionally, the one or more fields are also identified based on one or more operations of the facility, one or more user requirements, and one or more training requirements as well. The one or more training templates generated by the training management component 304 act as a framework to further generate the appropriate training modules.

Also, in one or more example embodiments, upon generation of the one or more training templates, the training management component 304 using the LLMs classifies the one or more training templates into one or more categories. In this regard, the one or more categories may be, but not limited to novice templates, intermediate templates, expert templates, templates with visuals or videos, operations specific templates, customer specific templates, topic specific templates, and/or the like. The training management component 304 classifies the one or more training templates based on the one or more topics, the one or more operations of the facility, the one or more user requirements, the one or more training requirements, the content in the one or more documents, and/or the like as well. Then, in one or more example embodiments, the users associated with the facility (such as, admins or personnel or even customers) provide one or more specifications to generate the one or more training modules. In this regard, the training management component 304 via the user interface 306 receives the one or more specifications from the users. The one or more specifications can be, but not limited to a description of training, a type of training, a level of training, an operation for which training is required, a worker or group of workforces that is to be trained, a threshold for selecting content from the one or more documents, and/or the like. For example, an admin in the facility may determine that a group of workers associated with material handling domain need to be upskilled for loading and unloading operations related to the material handling operations. In this regard, the admin may specifically provide a description of training as “instructions for loading and unloading operations”. The type of training may be indicative of content to be included in the training that is, whether the content should be audio, video, and/or textual content. The type of training may be also indicative of medium of training that is, offline training and/or computer-based training. The level of training may be based on level of expertise of workers required to take up the training. If the workers are to be newly trained, the admin may provide the level of training as novice training. Similarly, if the workers are having decent or medium experience, the admin may provide the level of training as intermediate training and if the workers are having great experience, the admin may provide the level of training as expert training. Also, in this example, the admin may select loading and unloading operations under the material handling operations for which training is required. Additionally, the users may select the group of workers as end users or targeted group of workers to be trained. Further, the threshold for selecting content from the one or more documents may be indicative of a benchmark for selecting appropriate vectorial representations and/or content to be included in the one or more training modules.

In one or more example embodiments, upon receipt of such specifications from the users, the training management component 304 using the LLMs select at least one template from the one or more templates based on the provided specifications. In this regard, the training management component 304 may analyze the one or more specifications provided by the users and compare the analyzed specifications with the one or more fields to select the at least one template. In response to selecting the at least one template, the training management component 304 using the LLMs identifies relevant content using the one or more vectorial representations of the one or more documents. In this regard, the training management component 304 may selectively choose the one or more vectorial representations based at least on the threshold provided by the users as a part of specifications. Using the selectively chosen vectorial representations, corresponding content from the one or more documents is identified using the LLMs. The training management component 304 using the LLMs then fills the one or more fields of the at least one template using the identified content. In this regard, the one or more fields of the at least one template is populated with relevant content such as audio, video, and/or textual content based on the provided specifications to generate the one or more desired training modules. In this regard, the one or more training modules may be, but not limited to control documents, forms, offline trainings, computer-based trainings, custom exams, online exams, online policies, Digi Script presentations, visual job aid, and/or the like. The one or more generated training modules are renderable via the user interface 306 as well. Further, in one or more example embodiments described herein, the training management component 304 identifies an interrelation between the one or more documents, the one or more topics, and the one or more templates to make sure that all relevant content is included in a training module for a particular topic. Also, the training management component 304 regularly updates the database with one or more new documents, one or more new topics, and one or more new templates to ensure that all latest and relevant data is available for generation of the one or more training modules. In this regard, the training management component 304 also updates existing training templates and/or training modules in the database using new documents, new topics, and/or new templates. The one or more training modules described herein facilitate upskilling of workforces in the facility in an optimized way which eventually enhances productivity of workforces and/or operations in the facility.

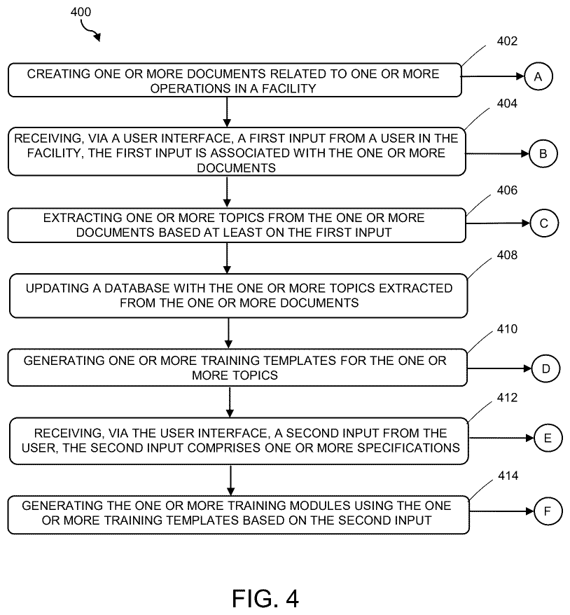

FIG. 4 illustrates a flowchart showing a method described in accordance with one or more example embodiments described herein. In this regard, FIG. 4 illustrates operations that may be performed by the module generating system 300. In some embodiments, the example method 400 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 400. At step 402 of the exemplary flowchart 400, the module generating system 300 comprises means such as, the document management component 302 to create one or more documents related to one or more operations in a facility. At step 404 of the exemplary flowchart 400, the module generating system 300 comprises means such as, the user interface 306 to receive a first input from a user in the facility. The first input is associated with the one or more documents related to the one or more operations in the facility. At step 406 of the exemplary flowchart 400, the module generating system 300 comprises means such as, the training management component 304 to extract one or more topics from the one or more documents based at least on the first input. At step 408 of the exemplary flowchart 400, the module generating system 300 comprises means such as, the training management component 304 to update a database with the one or more topics extracted from the one or more documents. At step 410 of the exemplary flowchart 400, the module generating system 300 comprises means such as, the training management component 304 to generate one or more training templates for the one or more topics. At step 412 of the exemplary flowchart 400, the module generating system 300 comprises means such as, the user interface 306 to receive a second input from the user. The second input comprises one or more specifications related to the one or more documents. At step 414 of the exemplary flowchart 400, the module generating system 300 comprises means such as, the training management component 304 to generate the one or more training modules using the one or more training templates based on the second input.

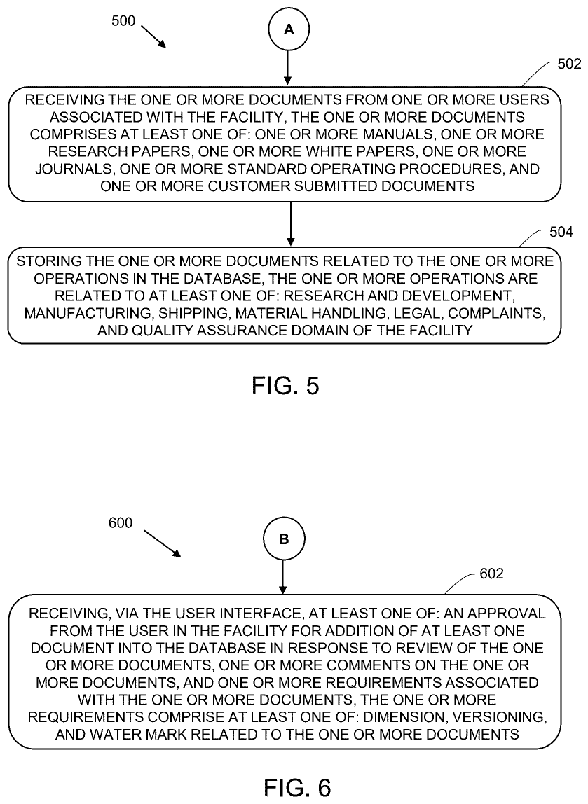

FIG. 5 illustrates a flowchart showing a method described in accordance with one or more example embodiments described herein. In this regard, FIG. 5 illustrates operations that may be performed by the module generating system 300. In some embodiments, the example method 500 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 500. At step 502 of the exemplary flowchart 500, the module generating system 300 comprises means such as, the document management component 302 to receive the one or more documents from one or more users associated with the facility. In this regard, the one or more documents comprises at least one of: one or more manuals, one or more research papers, one or more white papers, one or more journals, one or more standard operating procedures, and one or more customer submitted documents. At step 504 of the exemplary flowchart 500, the module generating system 300 comprises means such as, the document management component 302 to store the one or more documents related to the one or more operations in the database. In this regard, the one or more operations are related to at least one of: research and development, manufacturing, shipping, material handling, legal, complaints, and quality assurance domain of the facility.

FIG. 6 illustrates a flowchart showing a method described in accordance with one or more example embodiments described herein. In this regard, FIG. 6 illustrates operations that may be performed by the module generating system 300. In some embodiments, the example method 600 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600. At step 602 of the exemplary flowchart 600, the module generating system 300 comprises means such as, the user interface 306 to receive at least one of: an approval from the user in the facility for addition of at least one document into the database in response to review of the one or more documents, one or more comments on the one or more documents, and one or more requirements associated with the one or more documents. Also, the one or more requirements comprise at least one of: dimension, versioning, and water mark related to the one or more documents.

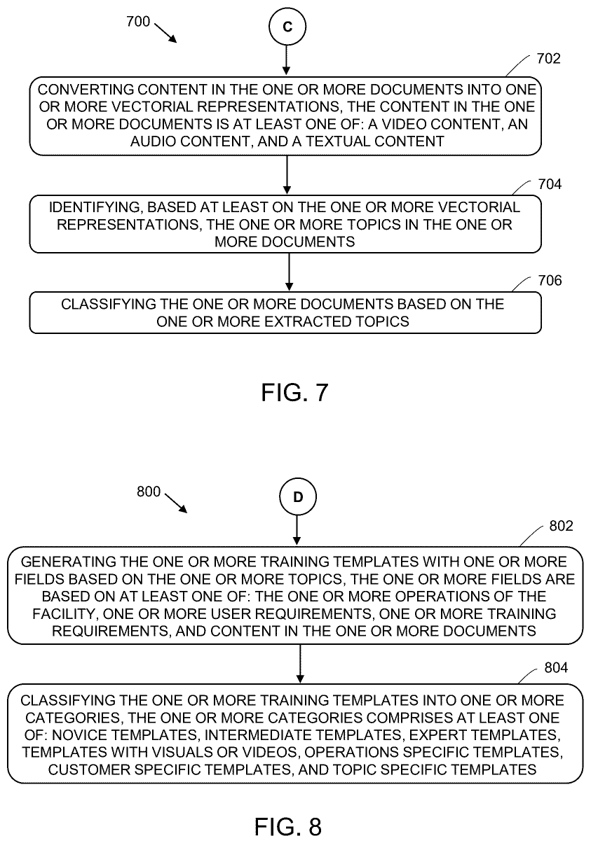

FIG. 7 illustrates a flowchart showing a method described in accordance with one or more example embodiments described herein. In this regard, FIG. 7 illustrates operations that may be performed by the module generating system 300. In some embodiments, the example method 700 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700. At step 702 of the exemplary flowchart 700, the module generating system 300 comprises means such as, the training management component 304 to convert content in the one or more documents into one or more vectorial representations. In this regard, the content in the one or more documents is at least one of: a video content, an audio content, and a textual content. At step 704 of the exemplary flowchart 700, the module generating system 300 comprises means such as, the training management component 304 to identify, based at least on the one or more vectorial representations, the one or more topics in the one or more documents. Then, at step 706 of the exemplary flowchart 700, the module generating system 300 comprises means such as, the training management component 304 to classify the one or more documents based on the one or more extracted topics.

FIG. 8 illustrates a flowchart showing a method described in accordance with one or more example embodiments described herein. In this regard, FIG. 8 illustrates operations that may be performed by the module generating system 300. In some embodiments, the example method 800 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 800. At step 802 of the exemplary flowchart 800, the module generating system 300 comprises means such as, the training management component 304 to generate the one or more training templates with one or more fields based on the one or more topics. In this regard, the one or more fields are based on at least one of: the one or more operations of the facility, one or more user requirements, one or more training requirements, and content in the one or more documents. At step 804 of the exemplary flowchart 800, the module generating system 300 comprises means such as, the training management component 304 to classify the one or more training templates into one or more categories. In this regard, the one or more categories comprises at least one of: novice templates, intermediate templates, expert templates, templates with visuals or videos, operations specific templates, customer specific templates, and topic specific templates.

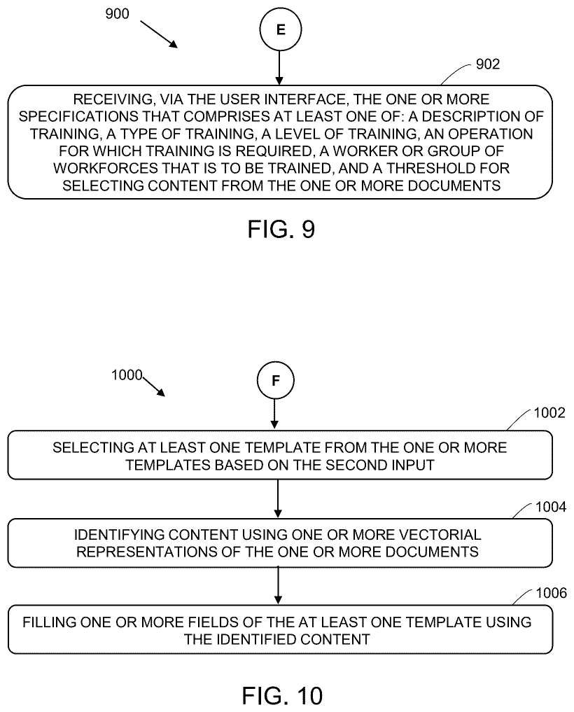

FIG. 9 illustrates a flowchart showing a method described in accordance with one or more example embodiments described herein. In this regard, FIG. 9 illustrates operations that may be performed by the module generating system 300. In some embodiments, the example method 900 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 900. At step 902 of the exemplary flowchart 900, the module generating system 300 comprises means such as, the user interface 306 to receive the one or more specifications that comprises at least one of: a description of training, a type of training, a level of training, an operation for which training is required, a worker or group of workforces that is to be trained, and a threshold for selecting content from the one or more documents.

FIG. 10 illustrates a flowchart showing a method described in accordance with one or more example embodiments described herein. In this regard, FIG. 10 illustrates operations that may be performed by the module generating system 300. In some embodiments, the example method 1000 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1000. At step 1002 of the exemplary flowchart 1000, the module generating system 300 comprises means such as, the training management component 304 to select at least one template from the one or more templates based on the second input. At step 1004 of the exemplary flowchart 1000, the module generating system 300 comprises means such as, the training management component 304 to identify content using one or more vectorial representations of the one or more documents. Then, at step 1006 of the exemplary flowchart 1000, the module generating system 300 comprises means such as, the training management component 304 to fill one or more fields of the at least one template using the identified content.

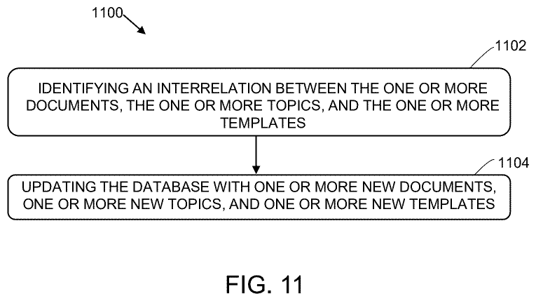

FIG. 11 illustrates a flowchart showing a method described in accordance with one or more example embodiments described herein. In this regard, FIG. 11 illustrates operations that may be performed by the module generating system 300. In some embodiments, the example method 1100 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1100. At step 1102 of the exemplary flowchart 1100, the module generating system 300 comprises means such as, the training management component 304 to identify an interrelation between the one or more documents, the one or more topics, and the one or more templates. Then, at step 1104 of the exemplary flowchart 1100, the module generating system 300 comprises means such as, the training management component 304 to update the database with one or more new documents, one or more new topics, and one or more new templates.

The foregoing embodiments are provided merely as illustrative examples and are not intended to require or imply that the steps of the various embodiments must be performed in the order presented. As will be appreciated by one of skill in the art the order of steps in the foregoing embodiments can be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray Disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation.

It is intended that the specification and examples be considered as exemplary only, with a true scope and spirit of the disclosure being indicated by the following claims.

1. A method for generating one or more training modules, the method comprising:
creating one or more documents related to one or more operations in a facility;
receiving, via a user interface, a first input from a user in the facility, wherein the first input is associated with the one or more documents;
extracting one or more topics from the one or more documents based at least on the first input;
updating a database with the one or more topics extracted from the one or more documents;
generating one or more training templates for the one or more topics;
receiving, via the user interface, a second input from the user, wherein the second input comprises one or more specifications; and
generating the one or more training modules using the one or more training templates based on the second input.

2. The method of claim 1, wherein creating the one or more documents related to the one or more operations comprises:
receiving the one or more documents from one or more users associated with the facility, wherein the one or more documents comprises at least one of: one or more manuals, one or more research papers, one or more white papers, one or more journals, one or more standard operating procedures, and one or more customer submitted documents; and
storing the one or more documents related to the one or more operations in the database, wherein the one or more operations are related to at least one of: research and development, manufacturing, shipping, material handling, legal, complaints, and quality assurance domain of the facility.

3. The method of claim 1, wherein receiving the first input from the user comprises:
receiving, via the user interface, at least one of: an approval from the user in the facility for addition of at least one document into the database in response to review of the one or more documents, one or more comments on the one or more documents, and one or more requirements associated with the one or more documents, wherein the one or more requirements comprise at least one of: dimension, versioning, and water mark related to the one or more documents.

4. The method of claim 1, wherein extracting the one or more topics from the one or more documents comprises:
converting content in the one or more documents into one or more vectorial representations, wherein the content in the one or more documents is at least one of: a video content, an audio content, and a textual content;
identifying, based at least on the one or more vectorial representations, the one or more topics in the one or more documents; and
classifying the one or more documents based on the one or more extracted topics.

5. The method of claim 1, wherein generating the one or more training templates for the one or more topics comprises:
generating the one or more training templates with one or more fields based on the one or more topics, wherein the one or more fields are based on at least one of: the one or more operations of the facility, one or more user requirements, one or more training requirements, and content in the one or more documents; and
classifying the one or more training templates into one or more categories, wherein the one or more categories comprises at least one of: novice templates, intermediate templates, expert templates, templates with visuals or videos, operations specific templates, customer specific templates, and topic specific templates.

6. The method of claim 1, wherein receiving the second input from the user comprises:
receiving, via the user interface, the one or more specifications that comprises at least one of: a description of training, a type of training, a level of training, an operation for which training is required, a worker or group of workforces that is to be trained, and a threshold for selecting content from the one or more documents.

7. The method of claim 1, wherein generating the one or more training modules using the one or more training templates based on the second input comprises:
selecting at least one template from the one or more templates based on the second input;
identifying content using one or more vectorial representations of the one or more documents; and
filling one or more fields of the at least one template using the identified content.

8. The method of claim 1, further comprising:
identifying an interrelation between the one or more documents, the one or more topics, and the one or more templates; and
updating the database with one or more new documents, one or more new topics, and one or more new templates.

9. A system for generating one or more training modules, the system comprising:
a processor;
a memory communicatively coupled to the processor, wherein the memory comprises one or more instructions which when executed by the processor, cause the processor to:
create one or more documents related to one or more operations in a facility;
receive, via a user interface, a first input from a user in the facility, wherein the first input is associated with the one or more documents;
extract one or more topics from the one or more documents based at least on the first input;
update a database with the one or more topics extracted from the one or more documents;
generate one or more training templates for the one or more topics;
receive, via the user interface, a second input from the user, wherein the second input comprises one or more specifications; and
generate the one or more training modules using the one or more training templates based on the second input.

10. The system of claim 9, wherein the processor is further configured to:
receive the one or more documents from one or more users associated with the facility, wherein the one or more documents comprises at least one of: one or more manuals, one or more research papers, one or more white papers, one or more journals, one or more standard operating procedures, and one or more customer submitted documents; and
store the one or more documents related to the one or more operations in the database, wherein the one or more operations are related to at least one of: research and development, manufacturing, shipping, material handling, legal, complaints, and quality assurance domain of the facility.

11. The system of claim 9, wherein the processor is further configured to:
receive, via the user interface, at least one of: an approval from the user in the facility for addition of at least one document into the database in response to review of the one or more documents, one or more comments on the one or more documents, and one or more requirements associated with the one or more documents, wherein the one or more requirements comprise at least one of: dimension, versioning, and water mark related to the one or more documents.

12. The system of claim 9, wherein the processor is further configured to:
convert content in the one or more documents into one or more vectorial representations, wherein the content in the one or more documents is at least one of: a video content, an audio content, and a textual content;
identify, based at least on the one or more vectorial representations, the one or more topics in the one or more documents; and
classify the one or more documents based on the one or more extracted topics.

13. The system of claim 9, wherein the processor is further configured to:
generate the one or more training templates with one or more fields based on the one or more topics, wherein the one or more fields are based on at least one of: the one or more operations of the facility, one or more user requirements, one or more training requirements, and content in the one or more documents; and
classify the one or more training templates into one or more categories, wherein the one or more categories comprises at least one of: novice templates, intermediate templates, expert templates, templates with visuals or videos, operations specific templates, customer specific templates, and topic specific templates.

14. The system of claim 9, wherein the processor is further configured to:
receive, via the user interface, the one or more specifications that comprises at least one of: a description of training, a type of training, a level of training, an operation for which training is required, a worker or group of workforces that is to be trained, and a threshold for selecting content from the one or more documents.

15. The system of claim 9, wherein the processor is further configured to:
select at least one template from the one or more templates based on the second input;
identify content using one or more vectorial representations of the one or more documents; and
fill one or more fields of the at least one template using the identified content.

16. The system of claim 9, wherein the processor is further configured to:
identify an interrelation between the one or more documents, the one or more topics, and the one or more templates; and
update the database with one or more new documents, one or more new topics, and one or more new templates.

17. A non-transitory, computer-readable storage medium having stored thereon executable instructions that, when executed by one or more processors, cause the one or more processors to:
create one or more documents related to one or more operations in a facility;
receive, via a user interface, a first input from a user in the facility, wherein the first input is associated with the one or more documents;
extract one or more topics from the one or more documents based at least on the first input;
update a database with the one or more topics extracted from the one or more documents;
generate one or more training templates for the one or more topics;
receive, via the user interface, a second input from the user, wherein the second input comprises one or more specifications; and
generate one or more training modules using the one or more training templates based on the second input.

18. The non-transitory, computer-readable storage medium of claim 17, wherein the one or more processors is further configured to:
receive the one or more documents from one or more users associated with the facility, wherein the one or more documents comprises at least one of: one or more manuals, one or more research papers, one or more white papers, one or more journals, one or more standard operating procedures, and one or more customer submitted documents; and
store the one or more documents related to the one or more operations in the database, wherein the one or more operations are related to at least one of: research and development, manufacturing, shipping, material handling, legal, complaints, and quality assurance domain of the facility.

19. The non-transitory, computer-readable storage medium of claim 17, wherein the one or more processors is further configured to:
receive, via the user interface, at least one of: an approval from the user in the facility for addition of at least one document into the database in response to review of the one or more documents, one or more comments on the one or more documents, and one or more requirements associated with the one or more documents, wherein the one or more requirements comprise at least one of: dimension, versioning, and water mark related to the one or more documents.

20. The non-transitory, computer-readable storage medium of claim 17, wherein the one or more processors is further configured to:
convert content in the one or more documents into one or more vectorial representations, wherein the content in the one or more documents is at least one of: a video content, an audio content, and a textual content;
identify, based at least on the one or more vectorial representations, the one or more topics in the one or more documents; and
classify the one or more documents based on the one or more extracted topics.
